(19) United States
(12) Patent Application Publication
(10) Pub. No.: US 2019/0139063 A1
(43) Pub. Date: May 9, 2019

(54) METHODOLOGY OF ANALYZING INCIDENCE AND BEHAVIOR OF CUSTOMER PERSONAS AMONG USERS OF DIGITAL ENVIRONMENTS

(71) Applicant: CARS.COM, LLC, Chicago, IL (US)

(72) Inventors: Zachary Lamm, Chicago, IL (US); Melissa Wittler, Chicago, IL (US); Amanda Kaleta-Kott, Chicago, IL (US); Laurel McDowall, Chicago, IL (US)

(21) Appl. No.: 15/803,181

(22) Filed: Nov. 3, 2017

(51) Int. Cl. G06Q 30/02; G06F 17/30; H04L 29/08

(52) U.S. Cl. CPC G06Q 30/0204; G06Q 30/0203; H04L 67/306; G06F 17/30867; G06Q 30/0278; G06Q 30/0201

(57) ABSTRACT

Systems and methods for identifying and managing user personas relating to user behavior within an digital environment are disclosed. Users interact with electronic data, such as online marketplaces, in different but predictable ways indicated by predefined user personas. To associate user interactions with user personas without the need for a user account or other identifying information, a user persona indicator may be generated and associated with user interactions within the digital environment during one or more user session. This enables utilization of information regarding a characteristic type of the user in analyzing user activity and predicting user actions. The data transmitted to the user may be adjusted based upon the user persona or predicted user actions.

### TECHNICAL FIELD

The present disclosure generally relates to systems and methods for improving identification of user personas (i.e., characteristic types or groups of users) based upon monitoring and evaluating user online interactions.

### BACKGROUND

User personas are representative fictional characters or characteristic types of user that embody certain attitudes and behaviors of large groups of users in relation to their interaction with an organization. This methodology allows researchers to segment a user population into persona groups based on actual user characteristics and to observe distinct patterns of behaviors associated with each persona group. A plurality of user personas are first determined, then users are identified with the personas based upon known characteristics of the users (e.g., age, residence, income, education). Because the known characteristics are often separate from the relevant behaviors, the identification of user personas is inaccurate. Moreover, identifying information regarding the users must initially be collected, before assigning personas to the users. Within digital environments, such as online vehicle search environments, the collection of user information is inherently limited by the nature of electronic communications. While some information regarding some users may be obtained through user account profiles, there is no general means of identifying user personas and connecting such user personas with interactions of users with a data source (e.g., a web site) for users who have not created user account or who are not logged in to user accounts. This difficulty limits the ability of researchers and others to accurately determine the incidence of each type of user persona in interactions in a digital environment. Additionally, this difficulty limits the potential for user-specific customization or predictions based upon user personas.

### SUMMARY

The present application discloses a method, system, and computer-readable medium storing instructions for improving online user interaction evaluation and persona identification. The method, system, or instructions may include receiving a user request from a user computing device to access data (such as vehicle data associated with a vehicle or vehicle dealer); determining survey content to present to a user of the user computing device; sending the survey content for presentation to the user via a display of the user computing device; receiving a user response to the survey content from the user computing device; generating an indicator of a user persona based upon the received user response; sending the data associated with the user request to the user computing device; storing a record associated with the user, including the indicator of the user persona and an indicator of the user request; and/or generating a prediction regarding a user action based upon the record associated with the user. The user persona may indicate a characteristic type associated with the user concerning user behavior relating to the requested data. In some embodiments, the indicator of the user persona may be associated with the user response to the survey content.

Some embodiments may include receiving one or more additional user requests for additional data, which may be associated with one or more vehicles or vehicle dealers. In response to such requests, the indications of the one or more additional user requests may be stored in the record associated with the user. One or more of the additional user requests may be received during a first user session at a first time, while the user request is received during a second user session at a second time after the first time. A file including an indication of the one of the one or more additional user requests received during the first time period may be stored in a memory of the user computing device during the first time period, an indication of which may be received later during the second time period. Based upon the indication of the file, the one or more additional user requests received during the first time period may be associated with the record, without reference to a user account.

In further embodiments, the prediction regarding the user action may include a predicted time of a vehicle purchase by the user. The prediction of the time of the vehicle purchase may be generated by identifying a first user request associated with a vehicle search by the user (the vehicle search being associated with the user request), determining a predicted time in market for the user based upon the user persona (the predicted time in market indicating an average duration of vehicle searches for users matching the user persona of the user), and determining the predicated time of the vehicle purchase as a time that occurs after the first user request by the predicted time in market. The user request may be the first user request in some cases. Yet further embodiments may include determining additional data to present to the user based upon the user persona and the prediction regarding the user action, as well as sending such additional data for presentation to the user via the display of the user computer device.

Still further embodiments may include receiving one or more additional user requests associated with additional data related to the user request from the user computing device (such as one or more additional vehicles or vehicle dealers). The one or more additional user requests may be associated with the user by the user persona indicator. User interaction metrics may then be determined based upon the user request and the one or more additional user requests. In some embodiments, a report including information regarding the user interaction metrics may be generated and/or sent to an analyst computing device for evaluation.

In various embodiments, additional, fewer, or alternate actions may be included or performed by the method, system, and computer-readable medium, including those discussed elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary data system on which the methods described herein may operate in accordance with the embodiments described herein;

FIG. 2 illustrates a block diagram of an exemplary computing device in accordance with the embodiments described herein;

FIG. 3 illustrates a sequence diagram of exemplary communication between various components of the data system;

FIG. 4 a flow diagram of an exemplary user interaction monitoring method for determining a user persona and monitoring user interaction using the identified user persona;

FIG. 5 illustrates a flow diagram of an exemplary survey method for identifying a user persona relating to vehicle purchasing behavior of users of an online vehicle information service;

FIG. 6 illustrates a flow diagram of an exemplary user monitoring method for monitoring user interactions with data after a user persona has been determined for the user;

FIG. 7 illustrates a flow diagram of an exemplary user persona identification method for identifying a user persona based upon user interactions, without surveying the user;

FIG. 8 illustrates a flow diagram of an analysis method for obtaining and analyzing user interaction data associated with user personas.

### DETAILED DESCRIPTION

The invention described herein is related to methods and systems that identify user personas within a digital environment, such as a web site. The methods and systems also monitor user interactions within such environments and utilize user persona information to analyze such user interactions. A digital environment may include an online data source or service, such as an online platform for vehicle research and sales. Users may access such digital environments via a web site or mobile application. To better understand and predict user interactions, it is advantageous to analyze user behavior with user personas. Such user personas may also be used to adjust content presented to users in order to improve the user experience. As noted above, however, existing techniques of user tracking or monitoring do not facilitate such persona-based analysis. The methods and systems described herein facilitate such persona-based analysis. Additionally, the methods and systems described herein do not require the user personas to be associated with user accounts (either site-specific accounts or general accounts, such as e-mail accounts or social media accounts).

In general, user personas may indicate characteristic types associated with users with respect to user behavior regarding a relevant process, type of data, or type of data interactions. For example, user personas for vehicle purchasing behavior may include an explorer, an enthusiast, a specifier, and a pragmatist. The explorer persona is associated with users who search broadly and consider a large quantity of information. The enthusiast persona is associated with users who are highly engaged in the process and have strong interest in vehicles in general. The specifier persona is associated with users who are looking for a particular vehicle. The pragmatist persona is associated with users who are looking for an adequate vehicle with minimal engagement. User behavior differs significantly between these personas, so identifying user personas enables better analysis of user behavior patterns and improved user experience customization, as discussed below.

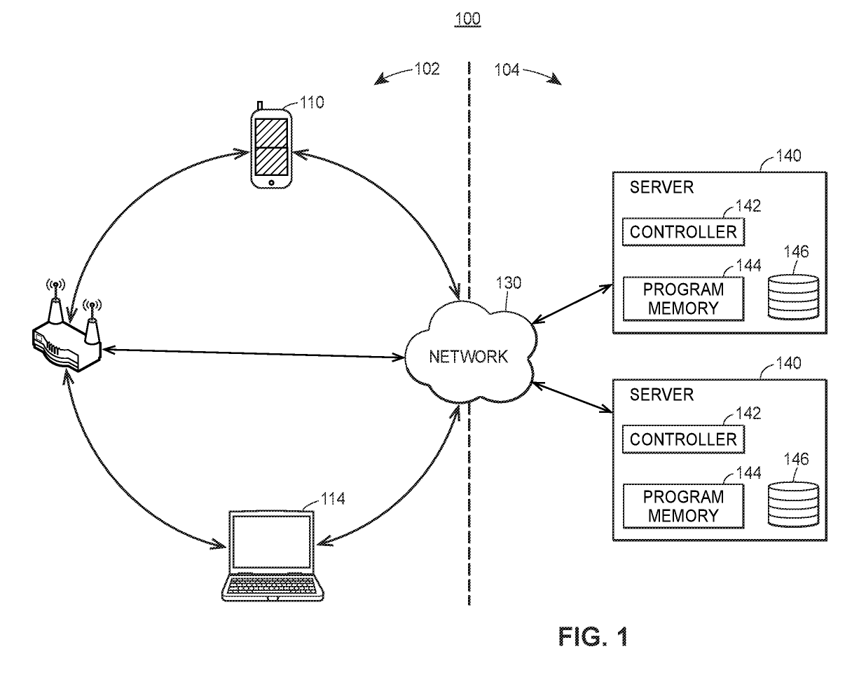

FIG. 1 illustrates a block diagram of an exemplary data system 100. The high-level architecture includes both hardware and software applications, as well as various data communications channels for communicating data between the various hardware and software components. The data system 100 may be roughly divided into front-end components 102 and back-end components 104. The front-end components 102 may communicate via a network 130 with the back-end components 104, as well as with other front-end components 102. For example, the front-end components 102 may include a plurality of computing systems communicatively connected to the back-end components 104 via the network 130. As illustrated, the computing systems may include one or more client computing devices 110 associated with a user (e.g., a smartphone of a customer) and one or more analyst computing device 114 associated with a reviewer or analyst of the data (e.g., a desktop computer, notebook, or tablet computer). The client computing device 110 may be used by a user to request and obtain data using one or more software programs, which data may include information regarding vehicles or vehicle dealers. The analyst computing device 114 may be used by an operator to request and review data regarding user interactions with the one or more client computing devices 110, which may be obtained by the analyst computing device 114 from one or more servers 140 via the network 130. In some embodiments, the analyst computing device 114 may instead be a back-end component 104, directly or indirectly connected to one or more servers 140. In further embodiments, the client computing devices 110 or the analyst computing devices 114 may communicate with one or more routers 112 to exchange data with each other or with the back-end components 104. Although one client computing device 110 and one analyst computing device 114 are shown, it should be understood that the data system 100 may include a plurality of each or either (e.g., hundreds or thousands of such devices). Any of the front-end components 102 may be directly or indirectly (e.g., through a router 112) connected to the network 130.

The back-end components 104 may operate in coordination with the front-end components 102 to collect, analyze, and present information. To this end, the back-end components 104 may include a server 140 that stores information received from the front-end components 102 via the network 130. The server 140 may further provide requested data requested to the front-end components 102, such as vehicle data or report data. In some embodiments, the back-end components 104 may include a plurality of servers 140 performing distinct or overlapping functions. For example, a first server 140 may perform user survey and/or persona determination functions, while a second server 140 may provide data in response to user requests and store information associated with such user requests for further analysis. Alternatively, one server 140 may perform any or all of the functions described herein. The server 140 may include a controller 142 to process data and run software programs, applications, or routines stored in a program memory 144 as executable instructions, and the server 140 may further include or be communicatively connected to a database 146 for data storage and retrieval.

The front-end components 102 may be arranged in various configurations including varying components depending upon user or analyst preferences. In some embodiments, the front-end components 104 may include a plurality of client computing devices 110 configured to access information from the server 140 via the network 130 and to communicate information to the server 140. In an exemplary embodiment described in detail herein, the front-end components 102 and back-end components 104 may be used to facilitate a vehicle research and purchase process for users, during which information regarding user interactions with the servers 140 (e.g., data requests) may be recorded for analysis, which data collection may be voluntary or may require affirmative user consent, in various embodiments. Correspondingly, the client computing devices 110 may be used to provide information to the servers 140 regarding user visits to dealerships, user research, and indications of user interest in specific vehicles or types of vehicles. Each of these client computing devices 110 may request data regarding vehicles or vehicle dealers through a general-purpose or special-purpose software application running on the device, such as from a web browser, a data service application, or a messaging application (e.g., via an automated or live communication session). The client computing devices 110 may obtain the data via the network 130 from a server 140, which server 140 may store information regarding the requests. The server 140 may further acquire and store information regarding user requests or user locations, based upon data received from the client computing devices 110. Such data may include user data requests, user responses to information requests (e.g., survey responses), user geospatial locations, or other information associated with user activities. Such information may be processed by the server 140 to generate reports of user data interaction of users or types of users. Such reports may be generated upon receipt of requests from analyst computing devices 114.

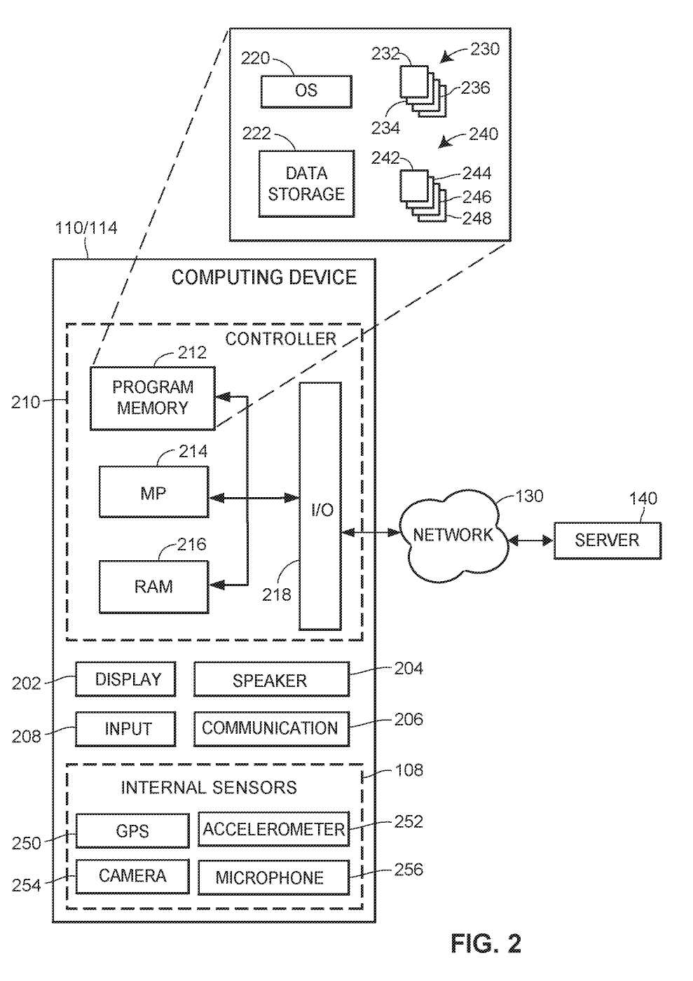

In various embodiments, the client computing devices 110 or analyst computing devices 114 may be any known or later-developed dedicated-use or general-use mobile personal computers, cellular phones, smartphones, tablet computers, or wearable computing devices (e.g., watches, glasses, etc.). For example, the client computing device 110 may be a general use smartphone or tablet computer with a web browser. In some embodiments, the client computing device 110 may be a thin client device, wherein much or all of the computing processes are performed by the server 140, with information communicated between the thin client device and the server 140 via the network 130. The client computing device 110 may include any number of internal components and may be further communicatively connected to one or more external components by any known wired or wireless means (e.g., USB cables, Bluetooth communication, etc.). An embodiment of the client computing device 110 and analyst computing device is further discussed below with respect to FIG. 2.

One or more routers 112 may be included within the data system 100 to facilitate communication. The routers 112 may be any wired, wireless, or combination wired/wireless routers using any known or here-after developed communication protocol for general- or special-purpose computer communication. In some embodiments, the client computing devices 110 or analyst computing devices 114 may be communicatively connected to the network 130 via one or more routers 112. Wireless communication may occur by any known means, such as Bluetooth, Wi-Fi, or other appropriate radio-frequency or other communications protocols.

The front-end components 102 communicate with the back-end components 104 via the network 130. The network 130 may be a proprietary network, a secure public internet, a virtual private network or some other type of network, such as dedicated access lines, plain ordinary telephone lines, satellite links, cellular data networks, combinations of these, etc. Where the network 130 comprises the Internet, data communications may take place over the network 130 via an Internet communication protocol.

The back-end components 104 include one or more servers 140. Each server 140 may include one or more computer processors within the controller 142 adapted and configured to execute various software applications and routines of the data system 100 stored in the program memory 144, in addition to other software applications. The controller 142 may include one or more processors (not shown), a random-access memory (RAM) (not shown), the program memory 144, and an input/output (I/O) circuit (not shown), all of which may be interconnected via an address/data bus (not shown). The RAM and program memory 144 may be implemented as semiconductor memories, magnetically readable memories, optically readable memories, or any other type of known or hereafter developed memory capable of storing executable instructions for execution by computer processors, such as the controller 142. The server 140 may further include one or more databases 146, which may be adapted to store data received from the front-end components 102, as well as data to be transmitted to the front-end components 102 (e.g., vehicle or vehicle dealer information). Such data might include, for example, information regarding vehicles listed for sale by vehicle dealers, information regarding average prices or ratings for vehicles of specified types, makes, models, or years, information regarding vehicle dealer inventory, hours, or customer ratings, or other information a customer may use in searching for or purchasing a vehicle. The server 140 may access data stored in the database 146 when executing various functions and tasks associated with the data system 100.

FIG. 2 illustrates a block diagram of an exemplary client computing device 110 or analyst computing device 114 in accordance with the data system 100. Because the analyst computing device 114 may, in some embodiments, be a desktop computer having additional or fewer components than the client computing device 110, the following description refers to the client computing device 110. It should be understood, however, that any combination of features described herein with respect to the client computing device 110 may be included in the analyst computing device 114.

The client computing device 110 may be a desktop computer, a notebook computer, a netbook computer, a smartphone, a tablet computer, or similar mobile or stationary computing device capable of receiving and processing electronic information. The client computing device 110 may include one or more internal sensors 108, which may provide sensor data regarding the local physical environment or the device's location therein. Such internal sensors 108 may likewise facilitate user input to the client computing device 110, such as by enabling the user to issue voice commands via a microphone 256. The client computing device 110 may further communicate with the server 140 via the router 112 and/or the network 130 to send and receive data. The data may be processed by the controller 210 to perform various operations for the user. Additionally, or alternatively, the data may be sent to one or more processors of the server 140 through the network 130 for processing. When the controller 210 (or other processor) receives an indication of a user action or request, appropriate responses are determined and implemented. Such responses may include processing data for presentation to the user, requesting data from the server 140, processing data from other front-end components 102 or back end components 104, determining information regarding the client computing device 110, sending data to the server 140, or presenting information to the user via a display 202 or speaker 204. In some embodiments, the client computing device 110 may include a communication unit 206 to send or receive information from local or remote devices (e.g., analyst computing device 114 or server 140), either directly or through the network 130. The communication unit 206 may include a wireless communication transceiver, such as a Wi-Fi or Bluetooth communication component. Further embodiments of the client computing device 110 may include one or more inputs 208 to receive instructions, selections, or other information from a user of the client computing device 110.

The client computing device 110 may include various input and output components, units, or devices. The display 202 and speaker 204, along with other integrated or communicatively connected output devices (not shown), may be used to present information to the user of the client computing device 110 or others. The display 202 may include any known or hereafter developed visual or tactile display technology, including LCD, OLED, AMOLED, projection displays, refreshable braille displays, haptic displays, or other types of displays. The one or more speakers 204 may similarly include any controllable audible output device or component, which may include a haptic component or device. In some embodiments, communicatively connected speakers 204 may be used (e.g., headphones, Bluetooth headsets, docking stations with additional speakers, etc.). The input 208 may further receive information from the user. Such input 208 may include a physical or virtual keyboard, a microphone, virtual or physical buttons or dials, or other means of receiving information. In some embodiments, the display 202 may include a touch screen or otherwise be configured to receive input from a user, in which case the display 202 and the input 208 may be combined.

The client computing device 110 may further include various internal sensors 108. The internal sensors 108 may include any devices or components mentioned herein, other extant or later-developed devices suitable for monitoring a physical environment (including device position or location within the environment). The sensors of the client computing device 110 may further include additional internal sensors 108 specifically configured for determining location or for tracking movement or spatial orientation of the device.

Although discussion of all possible sensors of the client computing device 110 would be impractical, if not impossible, several sensors warrant particular discussion. Disposed within the client computing device 110, the internal sensors 108 may include a GPS unit 250, an accelerometer 252, a camera 254, or a microphone 256. Any or all of these may be used to generate sensor data regarding the client computing device 110, its environment, user activity, or other relevant information. Additionally, other types of currently available or later-developed sensors may be included in some embodiments.

The GPS unit 250, the accelerometer 252, and the gyroscope 258 may provide information regarding the location or movement of the client computing device 110. The GPS unit 250 may use “Assisted GPS” (A-GPS), satellite GPS, or any other suitable global positioning protocol (e.g., the GLONASS system operated by the Russian government) or system that locates the position of the client computing device 110. For example, A-GPS utilizes terrestrial cell phone towers or Wi-Fi hotspots (e.g., wireless router points) to more accurately and more quickly determine location of the client computing device 110, while satellite GPS generally is more useful in more remote regions that lack cell towers or Wi-Fi hotspots.

The accelerometer 252 may include one or more accelerometers positioned to determine the force and direction of movements of the client computing device 110. In some embodiments, the accelerometer 252 may include a separate X-axis accelerometer, Y-axis accelerometer, and Z-axis accelerometer to measure the force and direction of movement in each dimension respectively. It will be appreciated by those of ordinary skill in the art that a three dimensional vector describing a movement of the client computing device 110 through three dimensional space can be established by combining the outputs of the X-axis, Y-axis, and Z-axis accelerometers using known methods. In some embodiments, one or more accelerometers 252, gyroscopes, or similar sensors may be disposed within a wearable device associated with a user, such that the sensor data therefrom may indicate movement of the user. Such sensor data may further be used to determine relative movements of the user over time. For example, movement data may be used to determine the length of time a user spends at a particular location, such as examining a particular vehicle on a vehicle dealer lot.

The camera 254 may be used to capture images of vehicles or other relevant objects in the user's environment. It should be understood that one or more cameras 254 may be disposed within the client computing device 110 and configured to generate either still images or video recordings. It should further be understood that many smartphones or tablet computers include front and back solid state digital cameras, which may be used to simultaneously obtain images of a large portion of the area before and behind the phone or tablet. In some embodiments, the camera 254 may include a flash or lighting device to illuminate the subject area. The microphone 256 may be used to monitor sounds within the local physical environment 106. One or more microphones 256 may be disposed within the client computing device 110 or may be communicatively connected thereto. The one or more microphones 256 may be used to record sounds or to receive voice commands from a user.

The client computing device 110 may also communicate with the router 112 or the network 130 using the communication unit 206, which may manage communication between the controller 210 and external devices. The communication unit 206 may transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 206 may also be capable of communicating using a near field communication standard (e.g., ISO/IEC 18092, standards provided by the NFC Forum, etc.). Furthermore, the communication unit 206 may provide input signals to the controller 210 via the I/O circuit 218. The communication unit 206 may also transmit sensor data, device status information, control signals, or other output from the controller 210 to one or more of the router 112, the network 130, or the server 140.

The client computing device 110 may further include a controller 210. The controller 210 may be configured to receive, process, produce, transmit, and store data. The controller 210 may include a program memory 212, one or more microcontrollers or microprocessors (MP) 214, a random access memory (RAM) 216, and an I/O circuit 218. The components of the controller 210 may be interconnected via an address/data bus or other means. It should be appreciated that although FIG. 2 depicts only one microprocessor 214, the controller 210 may include multiple microprocessors 214 in some embodiments. Similarly, the memory of the controller 210 may include multiple RAM 216 or multiple program memories 212. Although the FIG. 2 depicts the I/O circuit 218 as a single block, the I/O circuit 218 may include a number of different I/O circuits, which may be configured for specific I/O operations. The microprocessor 214 may include one or more processors of any known or hereafter developed type, including general-purpose processors or special-purpose processors. Similarly, the controller 210 may implement the RAM 216 and program memories 212 as semiconductor memories, magnetically readable memories, optically readable memories, or any other type of memory.

The program memory 212 may include an operating system 220, a data storage 222, a plurality of software applications 230, and a plurality of software routines 240. The operating system 220, for example, may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 222 may include data such as user profiles and preferences, application data for the plurality of applications 230, routine data for the plurality of routines 240, and other data necessary to interact with the server 140 through the digital network 130. In some embodiments, the controller 210 may also include, or otherwise be communicatively connected to, other data storage mechanisms (e.g., one or more hard disk drives, optical storage drives, solid state storage devices, etc.) that reside within the client computing device 110. Moreover, in thin-client implementations, additional processing and data storage may be provided by the server 140 via the network 130.

The software applications 230 and routines 240 may include computer-readable instructions that cause the processor 214 to implement data processing and communication functions. Thus, the software applications 230 may include a vehicle information application 232 to obtain and present information regarding vehicles and vehicle dealers, a web browser application 234 to obtain and present web-based content, or a mapping application 236 to present visual maps based upon user parameters. The software routines 240 may support the software applications 230 and may include routines such as a location routine 242 to determine a location of the client computing device 110 from GPS or other data, a communication routine 244 for communicating with the server 140 via the network 130, a data request routine 246 to allow a user to specify parameters for requesting data, and a data presentation routine 248 for generating or presenting received data to the user via the display 202. It should be understood that additional or alternative applications 230 or routines 240 may be included in the program memory 212, including other applications of the sort ordinarily stored on a mobile devices.

In some embodiments, the client computing device 110 may include a wearable computing device or may be communicatively connected to a wearable computing device. In such embodiments, part or all of the functions and capabilities of the client computing device 110 may be performed by or disposed within the wearable computing device. Additionally, or alternatively, the wearable computing device may supplement or complement the client computing device 110. For example, the wearable computing device 110 may be a smart watch with a display 202, a speaker 204 (or haptic alert unit), an input 208, and one or more internal sensors 108. Such smart watch may be communicatively connected to a smartphone and used interchangeably with the smartphone for some purposes (e.g., displaying information, providing user alerts, etc.).

The data system 100 described above and illustrated in FIGS. 1-2 may be used to perform the various user interaction monitoring, surveying, persona determination, and analysis methods discussed further below. Together, the methods described below relate to identifying user personas and connecting such user personas to user interactions with an online data source. The user interactions may be specifically associated with a user based upon a user persona indicator that also identifies a predefined persona associated with the user. Although the methods are described with reference to vehicles and vehicle dealers, the methods may be applied to other situations in which users interact with electronic data sources.

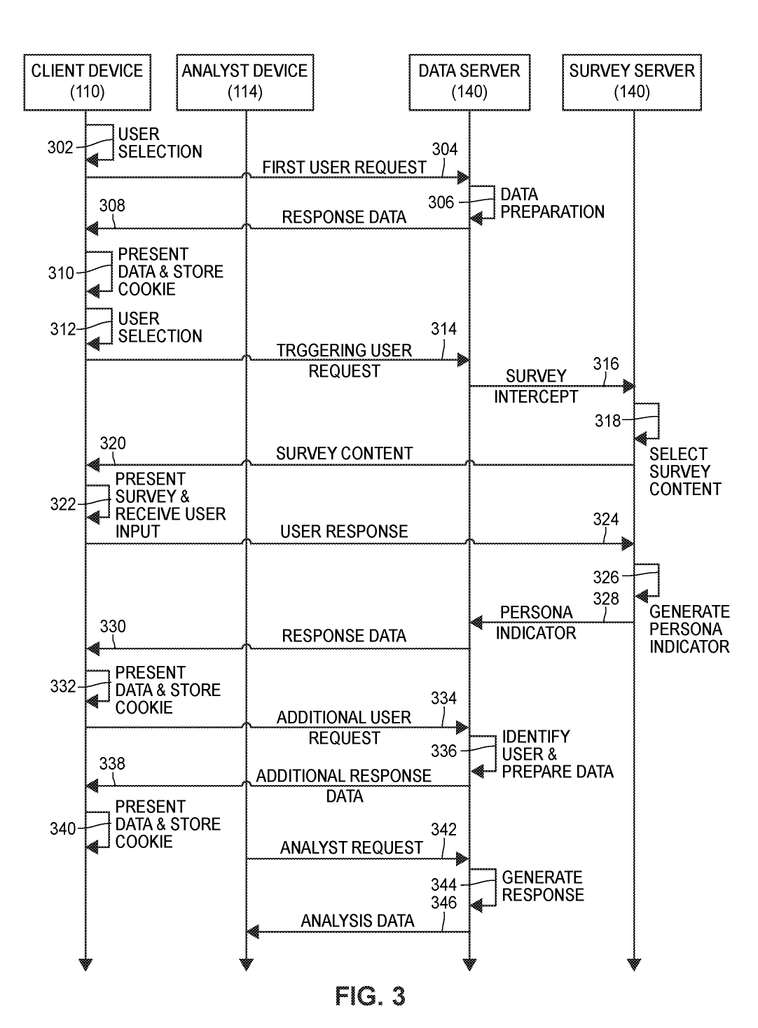

FIG. 3 illustrates a sequence diagram of exemplary communication between various components of the data system 100, discussed above. The illustrated communication may include electronic messages or other electronic communication between a client computing device 110, an analysis computing device 114, a data server 140, and a survey server 140. In alternative embodiments, the data server 140 and the survey server 140 (each of which are servers 140 as described above) may be combined into one server 140. The components may communicate via the network 130, as discussed above. The illustrated communication and corresponding description is exemplary only, and additional or alternative communications between any of the components (or additional or alternative components) may likewise be transmitted in other embodiments. The illustrated communication is presented to illustrate certain aspects of the invention involved in providing data to a user, surveying a user to establish a user persona for the user, and monitoring user interaction with the data to provide data for further analysis by an analyst.

The communication may begin with a user selection at the client computing device 110 (line 302) to indicate a demand for information from the data server 140. The user may indicate a selection via the display 202 of the client computing device 110 by interaction with an application executing thereon, which may be a general-purpose web browsing application or a special-purpose application (e.g., an app on a smartphone for searching, selecting, or purchasing vehicles). The user may indicate the data to be requested by clicking on a link or other indication presented via the application, or the user may indicate the data by inputting search criteria. The user may log in to a user account associated with the data (e.g., a user account for the application or web site), or the user may indicate a data request selection and proceed without ever creating or logging into such a user account. Indeed, the entire communication process and other methods described herein may, in some embodiments, occur with the user ever creating or logging into a user account (including without the user being identified by another user account, such as an e-mail account or social media account). In this way, the user can avoid the creation of another account or the linking of additional online services to existing accounts.

Upon receiving the user selection, the client computing device 110 may determine whether the data is locally available in the program memory 212 of the client computing device 110. When the user selection requires data from an outside data source (i.e., the data server 140), the client computing device sends a first user request to the data server 140 to obtain such data (line 304). The data request may be transmitted from the client computing device using a communication unit 206 via the network 130. The data request may specify the data to be returned, may specify parameters for determining the data to be returned (e.g., search parameters), or may specify a data location (e.g., a link or URL). The data request may be preprocessed or formatted by the client computing device 110 prior to transmission to the data server 140.

When the data server 140 receives the first user request, the data server 140 may prepare a response to the first user request (line 306). Preparing a response may include accessing data stored in a database 146 or other memory of the data server 140 (e.g., the program memory 144). Accessing such data may include querying a database for the data based upon information indicated by or derived from the first user request (e.g., search parameters extracted from the received first user message). If necessary, the data server 140 may request and obtain additional data (not shown) from another data source via the network 130. The data server 140 may process or package the data into a response prior to transmission to the user. In some embodiments, the data server 140 may also generate a cookie or other similar state identifying data structure to send to the client computing device 110, as part of or together with the response. Such cookie may be a session cookie or a persistent cookie to enable coherent responses to the user over time (e.g., over multiple user sessions) and to facilitate user interaction monitoring. When the response is prepared, the data server 140 sends a response data message (line 308) to the client computing device 110.

The client computing device 110 receives the response data from the data server 140 and presents the data to the user (line 310). All or part of the response data may be processed and formatted for presentation to the user via the display 202. In some embodiments, the client computing device 110 may further identify a cookie or similar state identifying data from the received response data message and store such cookie or similar data in the RAM 216 or program memory 212 of the client computing device 110. In alternative embodiments, the client computing device 110 may generate or update a similar data structure within the RAM 216 or program memory 212 of the client computing device 110 based upon the first user request message or the received response data message from the data server 140. The client computing device 110 may then wait for further user selections or instructions, which may occur in the same users session or in a later user session (i.e., after a period during which the application is not used and may be terminated). Use of a cookie or similar files or data structures enables the user interaction data from user interactions of multiple user sessions to be associated with the user at the data server 140, without reference to a user account.

When a further user selection (line 312) is received at the client computing device 110, the client computing device 110 may again process the user selection and determine an appropriate action. The appropriate action may include presenting further information or an alternative view of information to the user via the display 202, storing data in the data storage 222, or requesting additional data by sending another message to the data server 140. The additional data may be requested by sending an additional message, which may include a triggering user request. The client computing device 110 may generate and send a triggering user request message to the data server 140 (line 314). The triggering user request message may include a request for data that has been predetermined to trigger a process for determining a user persona (e.g., an indication of duration of a current session, an indication of the beginning of a subsequent session, an indication that the user has stored or saved certain data previously received from the data server 140, or other triggers). The triggering user request message may include information associated with or retrieved from a cookie on the client computing device 110. In some embodiments, the first user request may be a triggering user request by not including state data for the session from a cookie. In other embodiments, multiple user requests may be transmitted and responses received prior to a triggering user request. In any event, the triggering user request message causes the data server 140 to determine to begin a survey process as a site intercept prior to responding with the requested data.

When the data server 140 identifies the triggering content (or lack of content) in the triggering user request, the data server 140 may further communicate a survey intercept message to the survey server 140 (line 316). The survey intercept message includes information necessary to perform the survey function by sending survey content to the user, which may include an indication of a communication address for electronic communication with the client computing device 110. In some embodiments, the survey intercept message may include information indicating a survey content or type of survey to be used. Such information may include information regarding the data requested by the user, an indication of the type of data served by the data server 140, or information regarding the user (e.g., prior user interactions or information derived therefrom). For example, the survey intercept message may include cookie data received by the data server 140 from the client computing device 110 in the triggering user request message.

Upon receiving the survey intercept message, the survey server 140 may prepare the survey content to send to the user (line 318). The survey content may be prepared based upon the received survey intercept message, which may include determining a type of survey or questions to be asked. For example, the survey content may be selected to be content relating to personas regarding vehicle purchasing behavior of users, based upon the association of the user request with vehicle or vehicle dealer data. Alternatively, the survey server 140 may be configured to perform only one type of user persona survey, in which case the survey server 140 may nonetheless prepare a survey content message for transmission and presentation to the user. When the survey content has been prepared, the survey server 140 sends a survey content message to the client computing device 110 (line 320). The survey content may include one or more questions or prompts to be presented to the user in order to determine the user persona based upon the user's responses. Although illustrated as being communicated in one message, the survey content may instead by communicated from the survey server 140 to the client computing device 110 in a plurality of messages, some of which messages may depend upon user responses to preceding questions (i.e., the survey content may be adaptive based upon user response). The survey content message is also illustrated as being sent from the survey server 140 to the client computing device 110 for simplicity, but the survey content message may be sent from the survey server 140 to the data server 140 and from the data server 140 to the client computing device 110 in some embodiments.

When the client computing device 110 receives a survey content message, the survey content may be processed and presented to the user, and user input in response to the survey content may be received (line 322). The survey content may be presented to the user as one or more questions via the display 202, and the user may indicate responses to the questions (e.g., by selecting from among predefined responses or entering user comments) via the input 208. For example, a series of questions may be presented to the user until the user's answers to the questions provide sufficient information to determine the user persona. This may be based upon a deterministic or probabilistic approach, such as by reaching an end node in a decision tree associated with the questions or by calculating a degree of certainty regarding one or more user personas based upon user answers. The user's answers may be collected for a plurality of questions before responding to the survey server 140, or each answer may be separately sent to the survey server 140. Regardless, the client computing device 110 generates and sends a user response message (line 324) indicating one or more user answers (or summary data derived therefrom) to the survey server 140. If the survey is performed in an iterative manner, the survey content selection, survey content message transmission, survey content presentation, user response input, and user response message transmission may be repeated until the survey process is complete.

Once the survey server 140 has received sufficient user response data from the user, the survey server 140 may identify a user persona from among a predefined set of personas (line 326). Such identification of the user persona may be determined directly from user answers to questions or may be determined based upon indicative metrics calculated or derived from the user answers. For example, user text answers may be scored based upon word selection indicative of tone, which scores may be used to determine a user persona. Once determined, the survey server 140 may generate a user persona indicator to indicate the identified user persona. In some embodiments, the user persona indicator may include a reference or identifier of the survey responses of the user, which may be stored at the survey server 140. In further embodiments, the user persona indicator may include an indication specifically identifying one of the predetermined personas that has been identified as best representing the user based upon the user's responses. In some embodiments, the user personas may include a default user persona for users not otherwise classifiable.

When generated, the user persona indicator is sent from the survey server 140 to the data server 140 (line 328), where it may further be stored or otherwise associated with the user's interactions with the data server 140. For example, the data server 140 may include an indication of the user persona indicator or may include the user persona indicator itself in cookie data sent to the client computing device 110 along with requested data. The data server 140 may further store in the database 146 data regarding user data requests or other information regarding user interaction with the data provided by the data server 140 (e.g., additional data regarding user time spent viewing the data or selections within the data, which may be included within cookie data sent to the data server 140 from the client computing device 110). Upon receiving the persona indicator message from the survey server 140, the data server 140 may prepare and send a response data message to the client computing device 110 containing the data requested by the user (line 330). The client computing device 110 may receive, process, and present the response data to the user for further review and interaction (line 332).

As the user continues to interact with the application executing on the client computing device 110, information regarding such user interaction may be monitored or stored within the application, within a cookie, or within some other data structure on the client computing device 110. Such user interaction may further cause the application to generate and send one or more additional user request messages for further data (line 334) to the data server 140. Upon receiving such additional user request messages, the data serve 140 may prepare data for a response to the user (line 336). The data server 140 may further identify the user persona indicator associated with the user based upon the received additional user request message. The data server 140 may further store an indication of user interaction with the data in the database 146 based upon information included in the user request message, such as the type of data requested or user session information transmitted along with the data request. The data server 140 may then send an additional response data message to the client computing device 110 (line 338). Upon receipt of the additional response data message, the client computing device 110 may process and present the requested data to the user via the display 202 (line 340). This process may continue over one or more user sessions as long as the additional user interaction with the data continues to generate requests for further data from the data server 140.

During or after such additional user interaction, the data stored in the database 146 regarding the user interaction may be analyzed by an analyst operating the analyst computing device 114. The analyst may interact with an application executing on the analyst computing device 114 to request information from the data server 140, which may include information regarding interactions of one or more users with the data provided by the data server 140. For example, the analyst may request interaction data associated with all users associated with a particular user persona over a defined timeframe (e.g., within the past month, within the past year, etc.). Further parameters regarding the data may also be selected (e.g., user interactions for users who viewed data for a particular make or model of vehicle or who viewed data for a particular vehicle dealer). In some embodiments, the analyst computing device 114 may automatically generate an analyst request message with predetermined parameters on a periodic basis. Whether user-specified or automatically generated, the analyst device 114 may prepare and send an analyst request message to the data server 140 (line 342). In some embodiments, a corresponding analyst request message may be sent to the survey server 140 to obtain survey data associated with user persona indicators, or the data server 140 may obtain survey response data from the survey data 140 (not shown).

When the data server 140 receives the analyst request message, the data server 140 may identify the requested data and generate a response (line 344). To generate the response, the data server 140 may query the database 146 to obtain user interaction data relevant to the analyst request. In some embodiments, the data server 140 may generate a report or summary data regarding the user interaction data. Once the response is generated, the data server 140 sends an analyst data message including the response to the analyst computing device 114 (line 346). The response included in the analyst data message may be received, processed, and presented to the analyst by the analyst computing device 114. Further analysis may then be performed by the analyst using the data, and additional analyst requests for data may be sent to the data server 140.

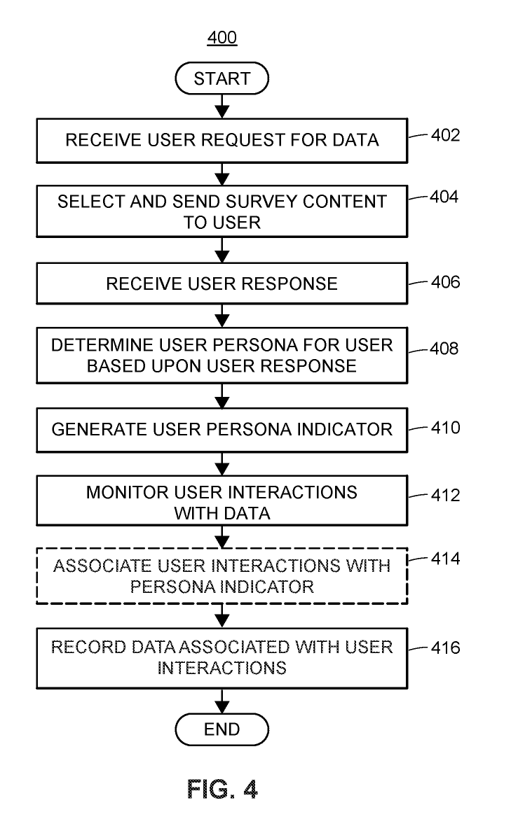

FIG. 4 illustrates a flow diagram of an exemplary user interaction monitoring method 400 for determining a user persona and monitoring user interaction using the identified user persona. The method 400 may be implemented by one or more servers 140 to handle user requests for data, as well as identify user personas and record interaction data associated with the user personas. Unlike existing techniques, the method 400 may be implemented to monitor user interaction with online data without requiring the user to create or log in to a user account. Instead, the method 400 associates a survey response with user interactions with online data, particular with data provided to a user from an online data source (e.g., a web site providing information regarding vehicles or vehicle dealers).

The exemplary user interaction monitoring method 400 may begin upon receipt of a user request for data at a server (block 402). The user request may be intercepted to perform a user persona survey by selecting and sending survey content to the user (block 404). The survey may be presented to the user, and user responses to survey questions may be sent to the server. Upon receiving one or more user responses to the survey content (block 406), the responses may be used to determine a user persona representing a characteristic behavioral type of the user (block 408). A user persona indicator may also be generated based upon the determined user persona (block 410), which user persona indicator may also be associated with the particular user survey response in some embodiments. The requested data may then be sent to the user, and further user interaction with the data may be monitored (block 412). Data regarding such additional user interactions may then be associated with the user persona indicator (block 414) and recorded for further analysis (block 416). In some embodiments, the exemplary method 400 may be modified to include alternative, additional, or fewer actions.

At block 402, the server 140 may receive a user request for data associated with the server 140. The request may be received via the network 130 from a client computing device 110 based upon interaction of a user with an application executing on the client computing device 110. The user request may be a specific request for particular data (such as a user-defined search), or the user request may be an indirect request for data (such as selecting a link within a web page). The server 140 may be a data server associated with a web site or mobile device application, in some embodiments. For example, the server 140 may be a web server hosting web pages containing data regarding vehicles for sale by individuals or vehicle dealers, in which case the user request may include a request to view a web page providing information regarding a particular vehicle offered for sale. Upon receiving the user request for data, the server 140 may determine whether the request is associated with a user for whom a user persona has already been determined. If no user persona has yet been determined, the server 140 may proceed to survey the user.

At block 404, the server 140 may select and send survey content to the client computer device 110. The survey content may be selected and prepared by the server 140, or the server 140 may communicate with another server 140 to survey the user. In some embodiments, the survey content may be varied based upon the user request. In other embodiments, the survey content may be fixed for all users requesting data from the server 140. Selecting the survey content may include accessing the survey content from the program memory 144 or from the database 146. The survey content may include one or more questions regarding user views or experiences, which may be used to match the user with one of a predefined set of personas associated with predicted user behavior. The server 140 may further prepare a message including the survey content, in some embodiments. When the survey content is ready to be transmitted to the user, the server 140 sends one or more messages including the survey content via the network 130 to the client computing device 110. The survey content may be sent to the client computing device 110 at one time or may be sent iteratively over a period of time (e.g., one question at a time as user responses are received). In some embodiments, the server 140 may run one or more applications or routines to select and send the survey content, such as the Qualtrics® survey tools developed by Qualtrics.

At block 406, the server 140 may receive one or more user responses to the survey content from the client computing device 110. The user responses may indicate answers of the user of the client computing device 110 to questions of the survey content, and such user responses may be received together or iteratively over a period of time. Once the user responses have been received, the server 140 may proceed to determine the user persona for the user. In some embodiments, the server 140 may execute a survey routine or application to perform the survey process, or the server 140 may utilize a survey component to perform the survey process, which may include selecting the survey content, sending the survey content to the user, and receiving (and storing) the user responses to the survey.

At block 408, the server 140 may determine a user persona for the user based upon the user responses. In some embodiments, the server 140 may execute a persona determination routine or utilize a persona determination component to determine the user persona. In some embodiments, the user persona may be identified from a predefined set of personas deterministically based upon a combination of survey responses by the user that uniquely indicate one of the predefined set of personas. In other embodiments, the user persona may be probabilistically determined from the predefined set of personas based upon a statistical best match of the user responses to a user persona. The determined user persona may then be associated with user interactions with the server 140.

At block 410, the server 140 may generate a user persona indicator to associate the user interactions with the determined user persona. The user persona indicator may directly indicate the identified user persona, or the user persona indicator may indirectly indicate the identified user persona by reference to stored survey results (i.e., user responses to the survey content). In some embodiments, the user persona indicator may include both a direct indication of the identified user persona and a reference to stored survey results. The user persona indicator may then be used to associate the user with user interactions with the data provided by the server 140 and allow analysis based upon user personas without requiring connecting the user interactions to a user account.

At block 412, the server 140 may monitor user interactions with the data provided by the data server 140. The server 140 may execute a monitoring routine or application to perform such monitoring of user interaction with online data, or the server 140 may utilize a monitoring component to perform such monitoring. For example, Omniture® user monitoring software tools developed by Adobe Systems Inc. may be used to monitor the user interactions and associate such interactions with the user persona indicator. Such user interaction monitoring may include using session or persistent cookies to identify the user's data interactions over time. Data regarding user interactions may be stored in the database 146 by the server 140, such as indication of data the user has requested, time spent on a web page, number of times a user viewed a web page, or types of vehicles viewed by the user.

At block 414, the server 140 may associate the user interactions with the determined user persona, if such user interaction data is not already associated with the user persona indicator. The user persona indicator may be associated with the monitored user interactions by maintaining a correspondence table in the database 146 relating user session identifiers (or multi-session identifiers) to the user persona indicators. The user session identifiers may be used to monitor user interactions with the data, which may then be further associated with the user profile indicators to enable further analysis. In some embodiments, survey results indicated by the user profile indicator may also be associated with the user interaction data.

At block 416, the server 140 may record the combined user persona indicator and user interaction data. In some embodiments, survey results may also be recorded with the user interaction data. Data regarding the user interactions with the data provided by the server 140 may be recorded for further use in analyzing interactions of the user or of groups of users sharing common characteristics (e.g., users having the same persona). The exemplary method 400 may then terminate.

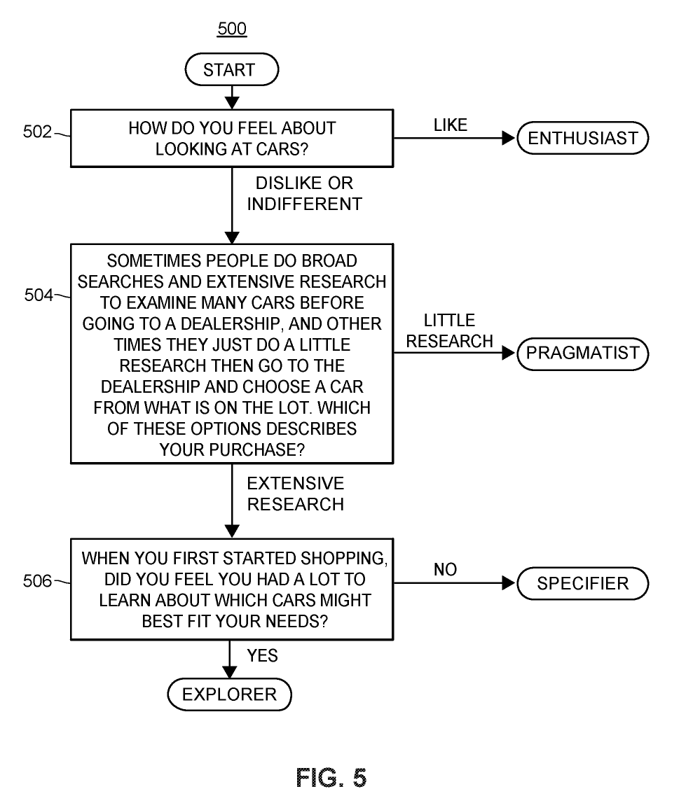

FIG. 5 illustrates a flow diagram of an exemplary survey method 500 for identifying a user persona relating to vehicle purchasing behavior of users of an online vehicle information service. The exemplary survey method 500 illustrates the use of one, two, or three questions to determine the user persona of a user, depending upon the user's responses. The exemplary survey assigns the user to one of four personas: an explorer, an enthusiast, a specifier, and a pragmatist. The exemplary personas indicate user engagement, investment, and sophistication regarding the process of finding and purchasing a vehicle, as discussed elsewhere herein. The exemplary method 500 may be implemented by the client computing device 110, which may receive the survey content from a server 140 and may send the user responses back to the server 140.

The exemplary survey method 500 begins at block 502 by presenting the user with a first question regarding the user's general attitude about searching for new vehicles (i.e., “How do you feel about looking at cars?”). A plurality of options may be presented to the user from which to select, such as “I love looking at cars,” “I don't mind looking at cars,” or “I prefer to be doing anything else.” If the user selects an option indicating the user enjoys searching for new vehicles, the survey may terminate and the user may be identified as associated with the enthusiast persona. If the user selects another option, a second question may be presented to the user at block 504 regarding a level of research the user intends to perform before making a purchase decision (e.g., “Sometimes people do broad searches and extensive research to examine many cars before going to a dealership, and other times they just do a little research then go to the dealership and choose a car from what is on the lot. Which of these options describes your purchase?”). Options may again be presented to the user for selection. If the user indicates an intent to do little research, the survey may terminate and the user may be identified as associated with the pragmatist persona. If the user selects another option, a third question may be present may be presented to the user at block 506 regarding the user's level of sophistication or specific goals with the vehicle purchase process (e.g., “When you first started shopping, did you feel you had a lot to learn about which cars might best fit your needs?”). Options may again be presented to the user for selection. If the user indicates a clear view of the vehicle sought, the survey may terminate and the user may be identified as associated with the specifier persona. If the user instead indicates a less clear view of the vehicle sought, the survey may terminate and the user may be identified as associated with the explorer persona. Thus, the three questions may suffice to identify a user persona based upon the user responses. Of course, the exemplary method 500 is only one of many possible survey methods, and other surveys regarding other user personas for vehicle purchase behavior or other user behavior may be used to identify user personas in other embodiments.

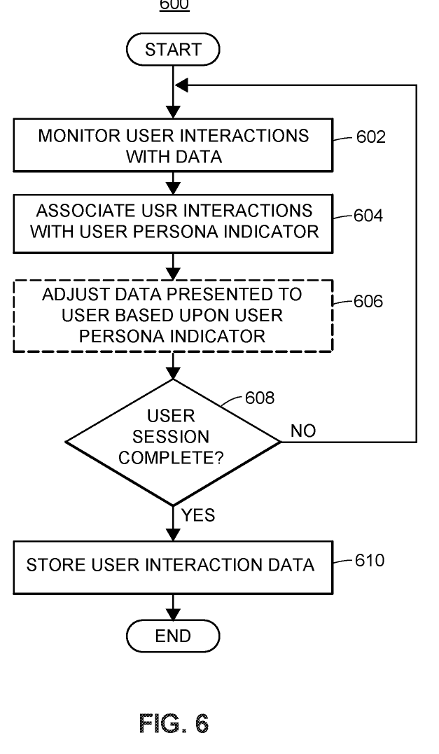

FIG. 6 illustrates a flow diagram of an exemplary user monitoring method 600 for monitoring user interactions with data after a user persona has been determined for the user. The exemplary method 600 may be implemented by one or more servers 140 to provide data to the user via the client computing device 110 and to record data regarding user interaction with the data. The exemplary method 600 may be performed to record user interaction data for a user session, such as a session of interaction with the data within a web browser running on the client computing device 110. Such user interaction data may be recorded for a plurality of user sessions over a course of days or months. As discussed elsewhere herein, the monitoring may be performed utilizing the user persona indicator to enable a limited user identification over time without requiring information regarding a user account (i.e., without requiring the user to create or log in to an account).

The exemplary user monitoring method 600 may begin by monitoring user interaction with data, such as an online data source (block 602). Such monitoring may occur continuously based upon user data requests. Each user interaction may be associated with a user persona indicator (block 604). In some embodiments, the data provided to the user may be adjusted based upon the persona indicator associated with the user (block 606). These actions may continue until the user session is determined to be complete (block 608), at which point the user interaction data may be stored in a manner associating the data with the user persona indicator (block 610). In some embodiments, the exemplary method 600 may be modified to include alternative, additional, or fewer actions.

At block 602, the server 140 may monitor user interaction with data provided by the server 140 or by another related server 140. Such monitoring may include tracking user data requests (e.g., search terms), maintaining a log of data sent to the user (e.g., indications of web pages sent to the user), identifying time spent viewing data, information regarding the client computing device (e.g., device type or location), or similar metrics, including those discussed elsewhere herein. In some embodiments, the server 140 may execute monitoring applications or routines, such as Omniture® user monitoring software tools developed by Adobe Systems Inc. to track user interaction. The resulting user interaction data may be stored in temporary or permanent memory for further analysis.

At block 604, the server 140 may associate the user interaction data with a user persona indicator for the user. Such user persona indicator may have been previously determined by a user survey or other techniques, as discussed elsewhere herein. The user persona may likewise be identified based upon data provided by the client computing device 110, such as an indication of state information from a cookie included with a user request or a device address of the client computing device 110. The user persona indicator may specify the user persona or may provide a unique user identifier associated with the user persona for the user. Associating the user interaction data with the user persona indicator provides information regarding user characteristics or a characteristic type of the user with respect to relevant behavior (e.g., vehicle purchasing behavior). Using the user persona indicator thus enables information regarding the user to be established and analyzed with the user interaction data, without requiring a user account.

At block 606, in some embodiments, the server 140 may adjust data presented to the user based upon the user persona. Because users associated with different personas typically interact with the data differently, the server 140 may adjust the data presented to the user to improve the user experience. For example, a response to a user request for data regarding a vehicle from a user associated with an explorer persona may include additional information regarding the vehicle, may add links to descriptions of the vehicle data (e.g., explanations of the effect of vehicle characteristics on performance or on operating or insurance costs), or may format the information in a manner to display all available information regarding the vehicle. In contrast, a response to the same user request for data regarding a vehicle from a user associated with a pragmatist persona may present only the most salient vehicle information in a tabular format, with some data initially hidden to allow the user to quickly obtain a summary of the vehicle (while enabling the user to drill down into further data, if desired). Because the user persona has been identified and associated with the user request, the response may thus be tailored to the expected user preferences. Such tailoring based upon user personas may be achieved for many more users by removing the need for the user to either create an account or connect their data requests to another account, which many users avoid. Such tailoring is further improved because relevant user selections are used to determine the user persona, rather than attempting to determine a user persona based upon demographic or other data of lower predictive value. In further embodiments, each of a predefined set of personas may be associated with data response and presentation or formatting characteristics. For example, different page templates or style sheets associated with the various personas may be stored on the server 140 and used in providing data in response to user requests for data.

In some embodiments, adjusting data presented to the user based upon the user persona may include adjusting the data presented to the user based upon a prediction of a user action, which prediction may be based upon the user persona. The prediction may include a time (e.g., a date, week, or day of the week) when the user is likely to make a vehicle purchase. Such prediction regarding a user action may be determined using the user persona indicator and user interaction data (e.g., a first user interaction or data request). Based upon such prediction regarding a user action, the server 140 may determine additional or alternative data to send to the client computing device 110 for presentation to the user via the display 202. Such additional or alternative data may include information regarding purchase options related to a user request, information regarding to purchase financing, or information regarding contact information for a seller. In some embodiments, the additional information may be sent to the user without a request if the user's contact information is known (e.g., a known e-mail address or phone number), which may further depend upon user consent to such contact in further embodiments.

At block 608, the server 140 may determine whether a user session is complete. This may include determining a time since the last user request has exceeded a timeout limit, or this may include receiving a session termination indication from the client device 110 (e.g., a user log-off if the user is signed in to an account, a disconnect from a synchronous data connection, a page-close message indicating that the user has closed a web page associated with the data, an app-close message indicating that the user has closed an application associated with the data, or a final action such as confirming a purchase). Any known techniques may be used to determine when the user session is complete. Until the user session is determined to have been completed, the method 600 may continue with monitoring user interactions at blocks 602-608. When the session is complete, the method may continue at block 610.

At block 610, the server 140 may store the user interaction data obtained by monitoring the user's actions during the user session. The user interaction data may be recorded in the database 146 or program memory 144 of the server 140. The stored user interaction data may be associated (either directly or through a reference to other stored data) with the user persona via the user persona indicator stored with the user interaction data. The stored user interaction data associated with the user persona indicator may be further associated with additional user interaction data from one or more additional user sessions over a period of time. Such user interaction data associated with the user persona may later be analyzed, as discussed elsewhere herein.

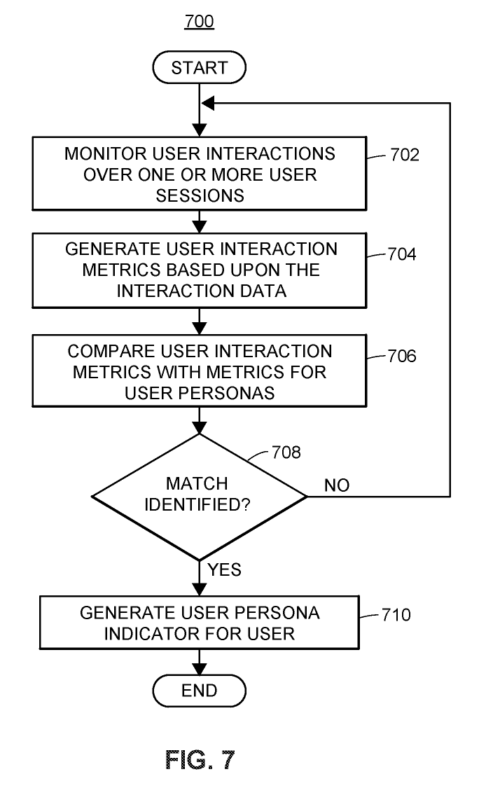

FIG. 7 illustrates a flow diagram of an exemplary user persona identification method 700 for identifying a user persona based upon user interaction with a data server 140, without surveying the user. Rather than identifying the user persona based upon survey responses of the user, the exemplary method 700 provides an alternative technique to determine a user persona based upon user interactions with the data. Such technique may be used with any of the monitoring and analysis techniques described elsewhere herein and further improves upon the other techniques described herein by eliminating or limiting the need for user survey responses, thereby further expanding the number of users for whom user personas may be identified. In some embodiments, the exemplary method 700 may be implemented in addition to the other methods herein. For example, the survey methods described above may be used to verify the user persona determination of the exemplary method 700. The exemplary method 700 may be implemented by one or more servers 140 to provide data to the user via the client computing device 110 and to record data regarding user interaction with the data. As discussed elsewhere herein, the exemplary method 700 may be implemented to determine the user persona indicator without requiring information regarding a user account.

The exemplary user persona identification method 700 may begin by monitoring user interaction with data, such as an online data source (block 702). Such monitoring may occur continuously based upon user data requests, as discussed above. User interaction metrics may then be generated from the user interaction data collected by monitoring the user interactions (block 704). The user interaction metrics may be compared with corresponding metrics associated with each of a plurality of predefined user personas (block 706), and such comparison may be evaluated to determine whether a match with one of the predefined user personas has been sufficiently identified (block 708). If no such match has been identified based upon the comparison of the user interaction metrics, monitoring may continue at block 702. If such match is identified, a user persona indicator may be generated and associated with the user (block 710). In some embodiments, the exemplary method 700 may be modified to include alternative, additional, or fewer actions.

At block 702, the server 140 may monitor user interaction with data provided by the server 140 or by another related server 140. Such monitoring may be performed according to the techniques described elsewhere herein or according to other known techniques to generate or collect user interaction data regarding the user's interaction with the data. The resulting user interaction data may be stored in temporary or permanent memory for further analysis.

At block 704, the server 140 may generate one or more user interaction metrics indicative of the behavior of the user with respect to the data. The one or more user interaction metrics may be generated based upon the user interaction data. The user interaction metrics may be related to the quantity, extent, scope, specificity, timing, or other aspects of user requests for data received by the server 140 from the client computing device. For example, a search specificity metric may indicate the number of vehicle makes or models covered by user searches (e.g., user requests associated with various vehicles or vehicle dealers), which may be relevant in determining whether the user is exploring various types of vehicle or has already selected a particular vehicle to purchase. As another example, the average time between user requests may be used as a proxy for the time a user spends reviewing the data on each of a plurality of web pages, which may indicate whether the user is interested in gleaning extensive details from the data or is simply looking for a few key pieces of information. The number of repeat requests for data previously received by the user may also be measured as an indicator of the degree to which the user is narrowing the search. Other similar user interaction metrics may be generated based upon the user interaction data, such as the following: total vehicle pages viewed, total vehicle dealer pages viewed, total time spent in a user session, degree of relatedness of pages viewed, user location, ratio of user requests for general information to user requests for specific vehicles or vehicle dealers, average duration of the shortest quarter of user page views, or average duration of the longest quarter of user page views. The user interaction metrics may be generated once a sufficient amount of user interaction data is available, in order to avoid extreme values of user interaction metrics based upon limited datasets.

At block 706, the server 140 may compare the generated user interaction metrics with corresponding user interaction metrics associated with each of a plurality of predefined user personas to attempt to identify a match. The predefined user personas may be associated with ranges of values for each of one or more user interaction metrics, which metrics may differ between personas. Thus, one or more subsets of the available user interaction metrics may be used to determine whether the user interaction matches one or more of the predefined user personas. The ranges of the predefined user personas may be exclusive, or it may be possible for the user interaction metrics to match more than one of the predefined user personas in some instances. In some embodiments, the comparison of the generated user interaction metrics and the corresponding user interface metrics associated with each of the predefined user personas may be performed in terms of a probability of a match. For example, the error or variance between averages of metrics for the predefined user personas and the generated values of the user interaction metrics may be calculated to determine a likelihood of a match for each of the predefined user personas.

At block 708, the server 140 may determine whether a sufficient match has been identified between the user interaction data and the predefined user personas based upon the comparison of the user interaction metrics with corresponding user interaction metrics associated with the predefined user personas. In some embodiments, the server 140 may determine whether a unique match has been identified between the user interaction metrics and one of the predefined user personas. In further embodiments, the server 140 may determine whether at least one sufficiently likely match exists. If more than one sufficient match has been identified, the more likely match may be selected as the match, or further user interaction may be monitored until only one sufficient match is identified. The sufficiency of matches may be determined based upon a probability threshold, or the sufficiency may be determined based upon the user interaction metrics being within ranges associated with one of the predefined user personas for key metrics or for a minimum number of metrics (which may be all metrics defining the persona, in some embodiments). If the server 140 cannot identify a unique match for the user interaction data, the method 700 may continue to monitor user interaction until such a match can be identified at blocks 702-708. Once a unique match is identified, the method 700 continues at block 710.

At block 710, the server 140 may generate a user persona indicator for the user based upon the identified match between the user interaction metrics and the predefined user personas. The user persona indicator may be associated with the user and stored in the database 146 or program memory 144, as discussed elsewhere herein. The method 700 may then terminate.

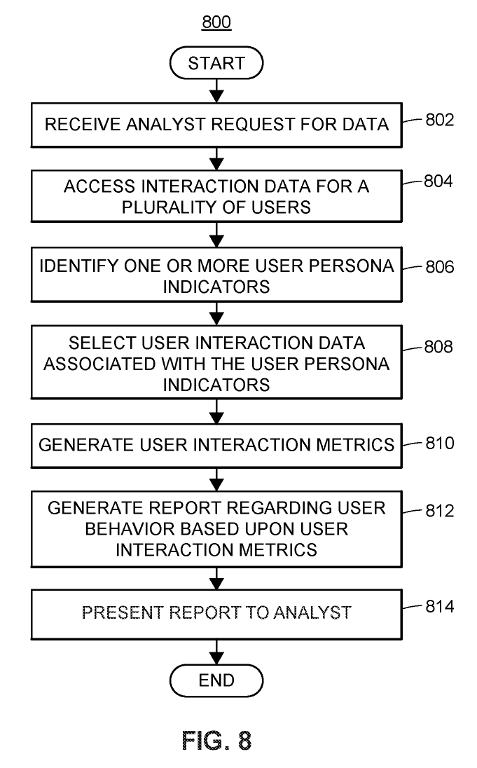

FIG. 8 illustrates a flow diagram of an exemplary analysis method 800 for obtaining and analyzing user interaction data associated with user personas. The exemplary method 700 may be implemented by one or more servers 140 to provide data for analysis of user behavior related to the user personas. The exemplary method 700 may be performed to select and provide stored user interaction data to an analyst in response to an analyst request received at a server 140 from an analyst computing device 114. As discussed above, the stored user interaction data may be associated with users based upon user persona indicators without requiring the users to create, log in, or connect to any user accounts. Thus, user persona information may be more generally available for analysis with the user interaction data, improving analysis accuracy.

The exemplary analysis method 800 may begin upon receipt of an analyst request to generate a user interaction report (block 802). Based upon such request, user interaction data associated with a plurality of users may be accessed (block 804). One or more user persona indicators may be identified (block 608), and user data associated with the one or more user persona indicators may be selected from the accessed data (block 808). One or more user interaction metrics may then be generated for the one or more users associated with the selected user interaction data (block 810). A user behavior report regarding the behavior of the one or more users may be generated based upon the user interaction metrics (block 812) and presented to the analyst for further review (block 814). In some embodiments, the exemplary method 800 may be modified to include alternative, additional, or fewer actions.

At block 802, the server 140 may receive an analyst request for information regarding user behavior based upon user interaction data from an analyst computing device 114. The analyst request may include parameters indicating limitations on the information requested, such as location, types of vehicles, types of user actions, types of user personas, or values of user interaction metrics. For example, the analyst request may indicate parameters indicating a timeframe, population, and user personas.

At block 804, the server 140 may access user interaction data for a plurality of users. The user interaction data may be accessed from a data source, such as the database 146 or program memory 144. In some embodiments, the user interaction data may be accessed by querying the data source to obtain a preliminary dataset. For example, the preliminary dataset may include data for a timeframe or location. The preliminary dataset may also be limited to user interaction data associated with one or more types of user personas, in some embodiments.

At block 806, the server 140 may identify one or more user persona indicators based upon the analyst request or the accessed user interaction data. For example, the one or more user persona indicators may be identified as user persona indicators associated with the accessed user interaction data, or such user persona indicators that further match one or more user personas indicated by the analyst request. In some embodiments, the user persona indicators may be identified based upon specific references to such user persona indicators in the analyst request, which may occur when updating a previous user behavior report. In further embodiments, the user persona indicators may be identified as all the user persona indicators associated with the data in the preliminary dataset. This may be useful in identifying only the user data in the preliminary dataset for which user persona information is available, as user persona indicators may not exist for all user interaction data stored in the data source.

At block 808, the server 140 may select a dataset of user interaction data associated with the one or more user persona indicators from the accessed user interaction data. The dataset may be selected from the preliminary dataset to obtain the user interaction data that matches analyst-specified parameters regarding the user interaction data and user personas or user persona indicators. In some embodiments, the dataset may be a subset of the preliminary dataset that includes only user interaction data associated with a user persona indicator. This dataset may be used for further analysis or may, in some embodiments, be directly incorporated into a report provided to the analyst.

At block 810, the server 140 may generate one or more user interaction metrics based upon the selected dataset of user interaction data. The user interaction metrics may indicate user behavior relative to data provided by the server 140 (or a related server 140) and may include any of the user interaction metrics descried elsewhere herein. In some embodiments, the user interaction metrics may include information indicative of the incidence of each of one or more predefined user personas within the population defined by the dataset. Such user interaction metrics may measure persona incidence based upon number of unique users or based upon total user interactions (measured by data requests, user sessions, or total user session time). In further embodiments, the user interaction metrics may include information regarding total time in market for each user (i.e., time elapsed since a first identified user interaction, time between the first identified user interaction and a process milestone defining the beginning or end of a process stage, or time between the first identified user interaction and a terminal interaction such as a purchase). In yet further embodiments, the user interaction metrics may include information regarding user time within a stage of a process (e.g., a planning stage, a discovering stage, a vetting stage, or a deciding stage). Such user interaction metrics may be useful in projecting likely future user actions and adjusting information presented to the user based upon such projected likely future user actions.

At block 812, the server 140 may generate a user behavior report based upon the user interaction metrics. The report may include summary data regarding individual users or groups of users (e.g., users grouped by user persona). The report may be prepared for analyst review, or the report may include the raw data for further processing and evaluation by the analyst computing device 114. In some embodiments, the report may include one or more predictions regarding a user action based upon the user interaction metrics and user persona indicator. Such predictions regarding user actions may include predicting a time at which a user may make a purchase decision or purchase a vehicle. Predicting when a user will make a vehicle purchase may include comparing the date of a first user interaction (or a current user stage in a process) with a predicted time in market for the user (e.g., an average total time in market before making a purchase for users having the same user persona). This may further include identifying the first user interaction (e.g., a first user request for data relating to a vehicle search that is associated with the user persona indicator) and determining the predicted time in market (indicating an average duration of vehicle searches for similar users associated with the same user persona) based upon the user persona associated with the user. The predicted time of vehicle purchase may be determined as a date that follows the first user interaction by a period equal to the predicted time in market.

At block 814, the server 140 may send the user behavior report to the analyst computing device 114 for presentation to the analyst via the display 202 or for further processing by the analyst computing device 114. The user behavior report may be presented to the analyst together with recommendations regarding predicted user actions, in some embodiments. The exemplary method 700 may then terminate.

### Other Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Although the foregoing text sets forth a detailed description of numerous different embodiments, it should be understood that the legal scope of the invention is defined by the words of the claims set forth at the end of this patent. The particular features, structures, or characteristics of any specific embodiment may be combined in any suitable manner and in any suitable combination with one or more other embodiments, including the use of selected features without corresponding use of other features. It is to be understood that other variations and modifications of the embodiments of the present invention described and illustrated herein are possible in light of the teachings herein and are to be considered part of the spirit and scope of the present invention. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A computer-implemented method for improving online user interaction evaluation and persona identification, comprising:
receiving, at one or more processors of a server, a user request from a user computing device to access vehicle data associated with a vehicle or vehicle dealer;
determining, by the one or more processors of the server, survey content to present to a user of the user computing device;
sending, form the server to the user computing device, the survey content for presentation to the user via a display of the user computing device;
receiving, at the one or more processors of the server, a user response to the survey content from the user computing device;
generating, by the one or more processors of the server, an indicator of a user persona based upon the received user response, wherein the user persona indicates a characteristic type associated with the user;
sending, from the server to the user computing device, the vehicle data associated with the user request;
storing, in a memory, a record associated with the user, including the indicator of the user persona and an indicator of the user request; and
generating, by the one or more processors of the server, a prediction regarding a user action based upon the record associated with the user.

2. The computer-implemented method of claim 1, further comprising:
receiving, at the one or more processors, one or more additional user requests for additional data associated with one or more vehicles or vehicle dealers; and
storing, in the memory, indications of the one or more additional user requests in the record associated with the user.

3. The computer-implemented method of claim 2, wherein:
at least one of the one or more additional user requests is received during a first user session at a first time; and
the user request is received during a second user session at a second time after the first time.

4. The computer-implemented method of claim 3, further comprising:
storing, in a memory of the user computing device during the first time period, a file including an indication of the at least one of the one or more additional user requests;
receiving, at the one or more processors of the server, an indication of the file including the indication of the at least one of the one or more additional user requests; and
associating, by the one or more processors of the server, the at least one of the one or more additional user requests with the record based upon the indication of the file, without reference to a user account.

5. The computer-implemented method of claim 1, wherein the prediction regarding the user action includes a predicted time of a vehicle purchase by the user.

6. The computer-implemented method of claim 5, wherein generating the prediction including the predicted time of the vehicle purchase includes:
identifying, by the one or more processors of the server, a first user request associated with a vehicle search by the user, wherein the vehicle search is associated with the user request;
determining, by the one or more processors of the server, a predicted time in market for the user based upon the user persona, wherein the predicted time in market indicates an average duration of vehicle searches for users matching the user persona of the user; and
determining, by the one or more processors of the server, the predicated time of the vehicle purchase as a time that occurs after the first user request by the predicted time in market.

7. The computer-implemented method of claim 6, wherein the user request is the first user request.

8. The computer-implemented method of claim 1, wherein the indicator of the user persona is further associated with the user response to the survey content.

9. The computer-implemented method of claim 1, further comprising:
receiving, at the one or more processors of the server, one or more additional user requests associated with one or more additional vehicles or vehicle dealers from the user computing device;
associating, by the one or more processors of the server, the one or more additional user requests with the user by the user persona indicator;
determining, by the one or more processors of the server, user interaction metrics based upon the user request and the one or more additional user requests; and
generating, by the one or more processors of the server, a report including information regarding the user interaction metrics.

10. The computer-implemented method of claim 1, further comprising:
determining, by the one or more processors of the server, additional data to present to the user based upon the user persona and the prediction regarding the user action; and
sending, from the server to the user computing device, the additional data for presentation to the user via the display of the user computer device.

11. A computer system for improving online user interaction evaluation and persona identification, comprising:
one or more processors;
a communication module adapted to communicate data via a network;
a program memory coupled to the one or more processors and storing executable instructions that, when executed by the one or more processors, cause the computer system to:
receive a user request from a user computing device via the communication module to access vehicle data associated with a vehicle or vehicle dealer;
determine survey content to present to a user of the user computing device;
send the survey content to the user computing device via the communication module for presentation to the user via a display of the user computing device;
receive a user response to the survey content from the user computing device via the communication module;
generate an indicator of a user persona based upon the received user response, wherein the user persona indicates a characteristic type associated with the user;
send the vehicle data associated with the user request to the user computing device via the communication module;
store a record associated with the user, including the indicator of the user persona and an indicator of the user request; and
generate a prediction regarding a user action based upon the record associated with the user.

12. The computer system of claim 11, wherein the executable instructions further cause the computer system to:
receive one or more additional user requests from the user via the communication module during a first time period preceding a second time period during which the user request is received; and
store indications of the one or more additional user requests in the record associated with the user.

13. The computer system of claim 12, wherein the executable instructions further cause the computer system to:
store a file including an indication of the at least one of the one or more additional user requests in a memory of the user computing device during the first time period;
receive an indication of the file including the indication of the at least one of the one or more additional user requests via the communication module; and
associate the at least one of the one or more additional user requests with the record based upon the indication of the file, without reference to a user account.

14. The computer system of claim 11, wherein the prediction regarding the user action includes a predicted time of a vehicle purchase by the user based upon a user interaction metric and a predicted time in market associated with the user persona.

15. The computer system of claim 11, wherein the executable instructions further cause the computer system to:
receive one or more additional user requests associated with one or more additional vehicles or vehicle dealers from the user via the communication component;
associate the one or more additional user requests with the user by the user persona indicator;
determine user interaction metrics based upon the user request and the one or more additional user requests; and
generate a report including information regarding the user interaction metrics.

16. A tangible, non-transitory computer-readable medium storing executable instructions for improving online user interaction evaluation and persona identification that, when executed by one or more processors of a computer system, cause the computer system to:
receive a user request from a user computing device to access vehicle data associated with a vehicle or vehicle dealer;
determine survey content to present to a user of the user computing device;
send the survey content for presentation to the user via a display of the user computing device;
receive a user response to the survey content from the user computing device;
generate an indicator of a user persona based upon the received user response, wherein the user persona indicates a characteristic type associated with the user;
send the vehicle data associated with the user request to the user computing device;
store a record associated with the user, including the indicator of the user persona and an indicator of the user request; and
generate a prediction regarding a user action based upon the record associated with the user.

17. The tangible, non-transitory computer-readable medium of claim 16, further storing executable instructions that cause the computer system to:
receive one or more additional user requests from the user during a first time period preceding a second time period during which the user request is received; and
store indications of the one or more additional user requests in the record associated with the user.

18. The tangible, non-transitory computer-readable medium of claim 17, further storing executable instructions that cause the computer system to:
store a file including an indication of the at least one of the one or more additional user requests in a memory of the user computing device during the first time period;
receive an indication of the file including the indication of the at least one of the one or more additional user requests; and
associate the at least one of the one or more additional user requests with the record based upon the indication of the file, without reference to a user account.

19. The tangible, non-transitory computer-readable medium of claim 16, wherein the prediction regarding the user action includes a predicted time of a vehicle purchase by the user based upon a user interaction metric and a predicted time in market associated with the user persona.

20. The tangible, non-transitory computer-readable medium of claim 16, further storing executable instructions that cause the computer system to:
receive one or more additional user requests associated with one or more additional vehicles or vehicle dealers from the user;
associate the one or more additional user requests with the user by the user persona indicator;
determine user interaction metrics based upon the user request and the one or more additional user requests; and
generate a report including information regarding the user interaction metrics.
